(19) United States
(12) Patent Application Publication
(10) Pub. No.: US 2014/0145564 A1
(43) Pub. Date: May 29, 2014

(54) ROTARY ELECTRIC MACHINE

(71) Applicant: DENSO CORPORATION, Kariya-city (JP)

(72) Inventors: Makoto TANIGUCHI, Obu-city (JP); Jirou HAYASHI, Ama-city (JP); Tatsuya INAGAKI, Nishio-city (JP); Akihito NAITOU, Nagoya-city (JP); Hiroki TOMIZAWA, Chiryu-city (JP); Masaaki YAMADA, Kariya-city (JP); Masashi YAMASAKI, Obu-city (JP); Yasufumi MATSUO, Nagoya-city (JP); Shuhei MIYACHI, Okazaki-city (JP); Nobuhiko URYU, Kariya-city (JP)

(73) Assignee: DENSO CORPORATION, Kariya-city (JP)

(21) Appl. No.: 14/027,625

(22) Filed: Sep. 16, 2013

(30) Foreign Application Priority Data
Nov. 28, 2012 (JP) 2012-259649

(51) Int. Cl. H02K 11/00

(52) U.S. Cl. CPC H02K 11/0005; H02K 11/0021
USPC 310/68 B

(57) ABSTRACT

A housing and a rotary shaft of a motor are formed of non-magnetic material. A soft magnetic member is provided between a first axial end surface of a fixed core and a bearing. The soft magnetic member is provided on the fixed core side relative to the first bearing thereby to suppress magnetic flux leaking to a vicinity of one end part of the rotary shaft by leading the magnetic flux, which is generated from a rotor, to the rotor core through the fixed core and a casing. A magnetic angular position sensor fixed to one end part of the rotary shaft can detect a magnetic angular position of the rotor accurately without being affected by external magnetic field. As a result, noise generated by vibration of the motor can be suppressed.

### CROSS REFERENCE TO RELATED APPLICATION

This application is based on and incorporates herein by reference Japanese patent application No. 2012-259649 filed on Nov. 28, 2012.

### TECHNICAL FIELD

The present disclosure relates to a rotary electric machine.

### TECHNICAL BACKGROUND

Recently a rotary electric machine such as a motor using permanent magnets realizes high output power by rare-earth permanent magnets. Among rare-earth magnets, neodymium-iron-boron magnet particularly has high performance. The rare-earth magnet is not supplied readily because its location of production is limited to only particular areas. It is therefore required to reduce the amount of use of such a magnet. JP-A-2010-0288349 discloses a rotor of a rotary electric machine, which is a consequent pole type, in which permanent magnets are arranged at only one side of a magnetic pole.

In the motor of consequent pole type, however, an entirety of yoke of the rotor is magnetized to the magnetic polarity of a part to which the permanent magnet contacts. The magnetic flux thus flows to turn around an outer peripheral part of the stator and return to a yoke central part of the rotor. This flow causes leaking of the magnetic flux to an outside of the motor. This phenomenon is particularly remarkable in a case where the stator is held by iron members.

Since a bearing for supporting a rotary shaft is normally made of iron steel material unless it is not for a specific use, the bearing operates as an inductor member, which is present in a magnetic path from the stator to the rotor and induces leaking of magnetic flux. The bearing thus generates a magnetic field near an end part of the rotary shaft. In a motor, in which a magnetic angular position sensor for detecting a rotational position of a rotor is located at an axial end part of a rotary shaft, magnetic flux leaking to an outside is mixed as an external disturbance in a magnetic filed distribution of the position sensor. This leaking magnetic flux is likely to lower the detection accuracy of the position sensor.

### SUMMARY

It is therefore an object to provide a rotary electric machine, which is capable of suppressing degradation of detection accuracy of a magnetic angular position sensor.

According to one aspect, a rotary electric machine comprises a housing made of a non-magnetic material; a bearing attached to the housing; a rotary shaft made of a non-magnetic material and supported by the bearing between a first axial end part and a second axial end part thereof; a magnetic angular position sensor provided for detecting a rotary position of the rotary shaft, the magnetic angular position sensor having a rotary part fixed to the first axial end part of the rotary shaft or an inner ring of the bearing; a rotor core fixed to the rotary shaft at a position, which is opposite to the rotary part in an axial direction of the rotary shaft relative to the bearing; plural salient poles protruding from the rotary core in a radial direction of the rotary shaft; plural magnet poles provided between adjacent two of the salient poles and fixed to the rotor core; a stator core fixed to the housing at a position radially outside the rotor core; plural coils wound and placed in slots of the stator core; and a soft magnetic member crossing in a first space between the bearing and a first end surface of the stator core at the bearing side. The soft magnetic member induces magnetic flux to flow from the stator core to the rotor core and suppresses the magnetic flux from flowing to the magnetic angular position sensor.

### BRIEF DESCRIPTION OF THE DRAWINGS

FIG. 1 is a longitudinal cross-sectional view of a motor according to a first embodiment;

FIG. 2 is a cross-sectional view of the motor taken along a line II-II in FIG. 1;

FIG. 3 is a schematic view of an electric circuit for the motor shown in FIG. 1;

FIG. 4 is a perspective view of a soft magnetic member shown in FIG. 1;

FIG. 5 is a sectional view showing, in two-dot chain lines, a part of magnetic flux, which is generated by a magnet pole of a rotor of the motor shown in FIG. 1;

FIG. 6 is a longitudinal cross-sectional view of a motor according to a second embodiment;

FIG. 7 is a longitudinal cross-sectional view of a motor according to a third embodiment;

FIG. 8 is a longitudinal cross-sectional view of a motor according to a fourth embodiment;

FIG. 9 is a longitudinal cross-sectional view of a motor according to a fifth embodiment;

FIG. 10 is a longitudinal cross-sectional view of a motor according to a sixth embodiment;

FIG. 11 is an exploded perspective view of a soft magnetic member, a clip and a first housing part of the motor shown in FIG. 10;

FIG. 12 is a longitudinal cross-sectional view of a motor according to a seventh embodiment;

FIG. 13 is an exploded perspective view of a soft magnetic member and a first housing part of the motor shown in FIG. 12;

FIG. 14 is a longitudinal cross-sectional view of a motor according to an eighth embodiment;

FIG. 15 is a longitudinal cross-sectional view of a motor according to a ninth embodiment;

FIG. 16 is a longitudinal cross-sectional view of a motor according to a tenth embodiment;

FIG. 17 is a longitudinal cross-sectional view of a motor according to an eleventh embodiment;

FIG. 18 is a longitudinal cross-sectional view of a motor according to a twelfth embodiment;

FIG. 19 is a longitudinal cross-sectional view of a motor according to a thirteenth embodiment; and

FIG. 20 is a perspective view of a part of a stator of a motor according to a fourteenth embodiment.

### EMBODIMENT

A rotary electric machine will be described below with reference to plural embodiments, in which the rotary electric machine is implemented as an electric motor. In the drawings, substantially the same component parts among the plural embodiments are designated by the same reference numerals thereby to simplify the description.

### First Embodiment

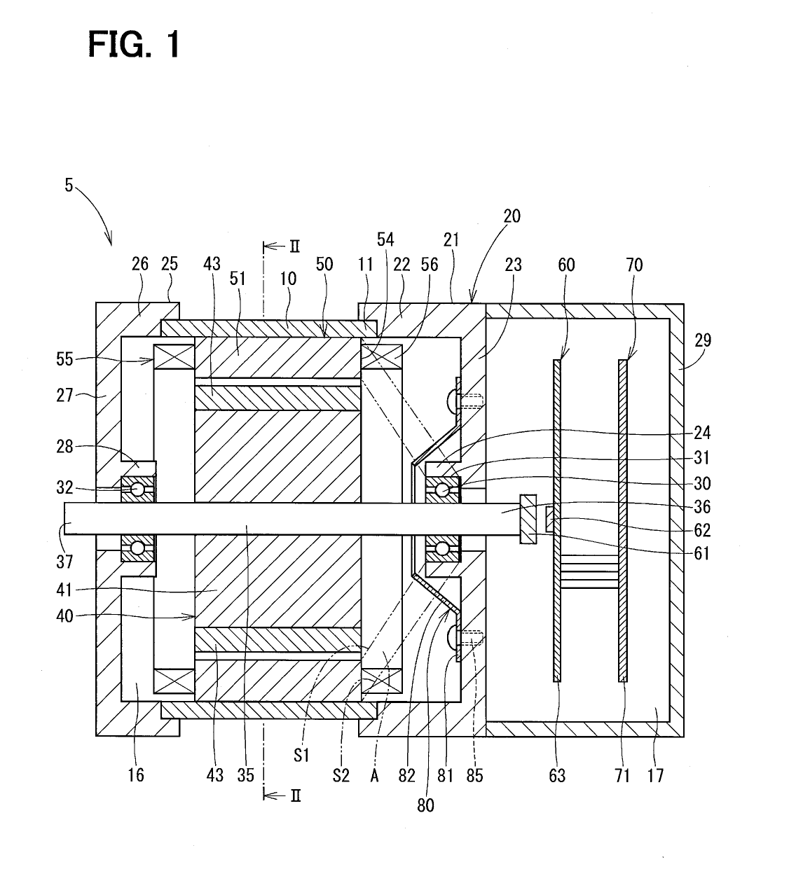

Referring first to FIG. 1 to FIG. 5, a motor 5 is configured as a drive power source for a vehicular electric power steering system (not shown). The motor 5 is a three-phase brushless motor and formed of a casing 10, a housing 20, a first bearing 30, a second bearing 32, a rotary shaft 35, a rotor 40, a stator 50, a magnetic angular position sensor 60 and an electronic drive control apparatus 70.

The casing 10 is a cylindrical member made of a soft magnetic material. The housing 20 is formed of a first housing part 21 and a second housing part 25, which are cup-shaped. The first housing part 21 is formed of a first cylindrical part 22 and a first bottom part 23. The first cylindrical part 22 is fixed to one axial end part of the casing 10 by spigot-joint fitting. The first bottom part 23 closes one axial end of the first cylindrical part 22 at a side opposite to the casing 10. The first bottom part 23 has a first bearing holder part 24, which extends in the axial direction toward the rotor 40. The second housing part 25 is formed of a second cylindrical part 26 and a second bottom part 27. The second cylindrical part 26 is fixed to the other axial end part of the casing 10 by spigot-joint fitting. The second bottom part 27 closes one axial end of the second cylindrical part 26 at a side opposite to the casing 10. The second bottom part 27 has a second bearing holder part 28, which extends in the axial direction toward the rotor 40.

The first bearing 30 is fitted in the inside part of the bearing holder part 24 of the housing 20. The second bearing 32 is fitted in the inside part of the bearing holder part 28 of the housing 20. The rotary shaft 35 is supported between a first axial end part 36 and a second axial end part 37 to be rotatable relative to the housing 20.

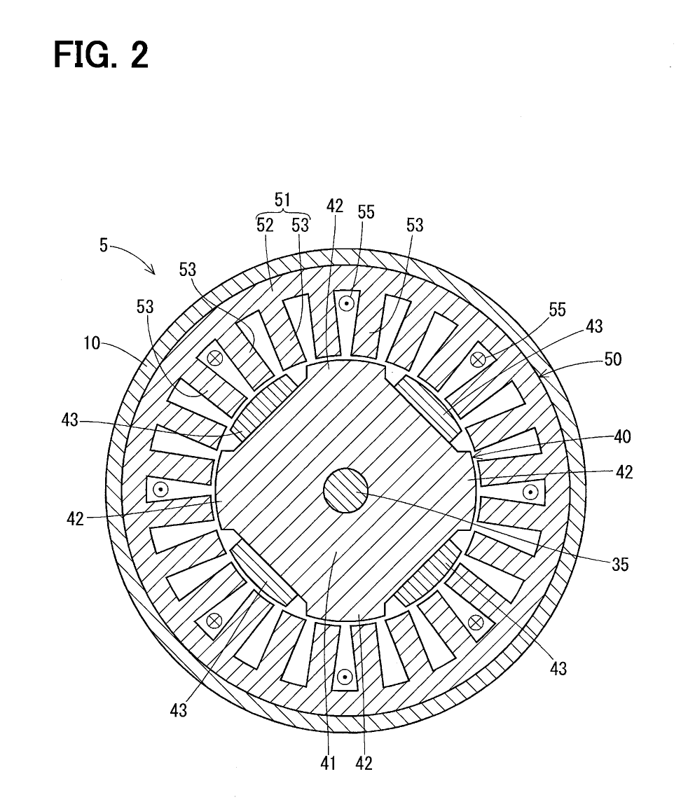

The rotor 40 is provided as a permanent magnet field of the motor 5 and, as shown in FIG. 2, formed of a rotor core 41, plural salient poles 42 and plural magnet poles 43. The rotor core 41 is made of a soft magnetic material, shaped generally cylindrically, located at a position opposite to one end part 36 relative to the first bearing 30, that is, between the first bearing 30 and the second bearing 32, and fixed to the rotary shaft 35 by press-fitting. The salient poles 42 are protrusions, which protrude from the rotor core 41 in a radially outward direction, and formed of the same material as the rotor core 41. Each salient pole 42 is arranged with a predetermined angular interval in a circumferential direction. The magnet poles 43 are formed of permanent magnets. Each magnet pole 43 is arranged between two adjacent salient poles 42 and fixed to the rotor core 41. Each magnet pole 43 is arranged such that the same magnetic polarity is oriented at the radially outer side. The salient pole 42 is magnetized to the polarity opposite to the outside polarity of the magnet pole 43. The rotor core 40 is thus a consequent pole-type rotor, in which the magnet pole 43 and the salient pole 42 magnetized in opposite directions or polarities are arranged alternately in a direction of rotation.

The stator 50 is an armature of the motor 5 and provided radially outside the rotor 40. The stator 50 is formed of a stator core 51 and plural coils 55. The stator core 51 is formed of a back yoke 52 and plural teeth 53. The back yoke 52 has an annular or cylindrical shape and is firmly fixed to an inside wall of the casing 10 by, for example, press-fitting. The plural teeth 53 extend in the radially inward direction from the back yoke 52. The coils 55 are formed of a U-phase coil, a V-phase coil and a W-phase coil. Each coil 55 is wound and inserted in a slot between adjacent teeth 53. In FIG. 2, only the U-phase coil is indicated by a symbol of the direction of current flow. The stator 50 is held coaxially with the rotary shaft 35 by fixing the casing 10, which fixes the stator core 51, to the housing 20 by spigot-joint fitting.

The magnetic angular position sensor 60 is formed of a permanent magnet 61, a magnetic sensor 62 and a control circuit panel 63. The permanent magnet 61 is fixed to the first axial end 36 of the rotary shaft 35 and hence a rotary part of the position sensor 60. The magnetic sensor 62 and the control circuit panel 63 correspond to a fixed part of the position sensor 60. The permanent magnet 61 is fixed to one end 36 of the rotary shaft 35. The magnetic sensor 62 is positioned closely to the permanent magnet 61 in a manner to oppose the permanent magnet 61 in the axial direction. The magnetic sensor 62 is a magneto-resistive element, which is responsive to a magnetic field parallel to its magnetism sensing plane, and outputs a signal to a control circuit (not shown) on the control circuit panel 63 in accordance with an internal resistance, which varies with a rotation of the permanent magnet 61. The control circuit calculates a rotation position of the rotary shaft 35, that is, a magnet pole position of the rotor 40, based on the signal inputted from the magnetic sensor 62, and outputs the calculation result to the electronic drive control apparatus 70.

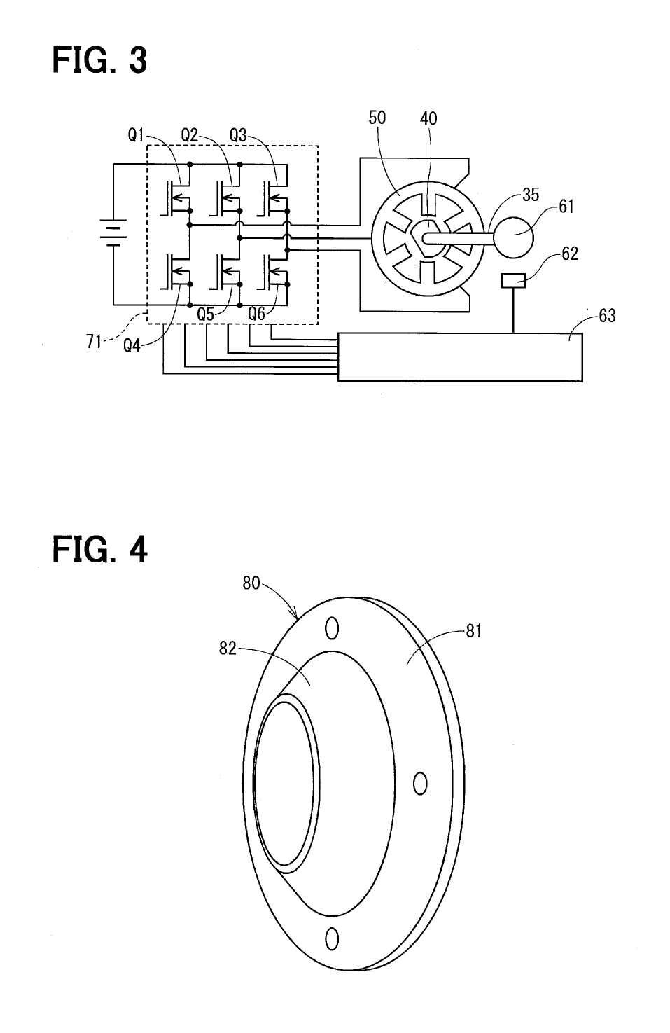

The drive control apparatus 70 is formed of a main circuit panel 71, which includes power transistors Q1, Q2, Q3, Q4, Q5, Q6 and the like as shown in FIG. 3. The drive control apparatus 70 controls the power transistors Q1 to Q6 in accordance with the magnetic pole position of the rotor 40 and switches over sequentially power supply to the coils 55 of each phase so that a rotating magnetic field is generated around the rotor 40. The rotor 40 is thus rotated by being attracted by the rotating magnetic field. The motor 5 is a machine-electronics-integrated device, in which a mechanical structural part and an electronic control part are integrated in a single body.

The first housing part 21, the casing 10 and the second housing part 25 of the housing 20 form a first accommodation compartment 16, which accommodates the rotor 40, the stator 50 and the like therein. The first housing part 21 and the cover 29, which is attached to the first housing part 21 at the axial side opposite to the casing 10, form a second accommodation compartment 17, which accommodates the first axial end 36 of the rotary shaft 35, the position sensor 60, the drive control apparatus 70 and the like therein. The first accommodation compartment 16 corresponds to a space, in which the rotor 40 is provided. The second accommodation compartment 17 corresponds to a space, in which the magnetic sensor 60 is provided. The first bottom part 23 of the housing 20 corresponds to a partition wall, which partitions or separates the first accommodation compartment 16 and the second accommodation compartment 17.

The characteristic configuration of the motor 5 will be described with particular reference to FIG. 1, FIG. 2 and FIG. 4. The rotary shaft 35 is formed of an austenitic stainless steel. The housing 20 and the cover 29 are made of die-cast aluminum.

The length of protrusion of one axial end part 11 of the casing 10, which protrudes from a specified end surface (first axial end surface) 54 of the stator core 51 toward the first bearing 30 in the axial direction, is shorter than coil end parts 56 of the coils 55 protruding from the first axial end surface 54. That is, the end part 11 of the casing 10 protrudes toward the first bearing 30 less than the coil end part 56 of the coil 55 and is retracted toward the second housing 25 side.

The motor 5 has a soft magnetic member 80. The soft magnetic member 80 is formed of a first flange part 81 and a transverse part 82 in an umbrella shape in a manner to cover the first bearing 30. The first flange part 81 is formed in an annular plane shape and fixed to the first bottom part 23 of the first housing part 21 by bolts 85. The transverse part 82 is formed in a conical tubular shape to extend from the radially inside edge of the first flange part 81 toward the radially inner part of the rotary core 41. The diameter of the transverse part 82 gradually decreases from the first flange part 81. The transverse part 82 thus crosses a space A provided between the first bearing 30 and the first axial end surface of the stator core 51, which is at the first bearing 30 side. The space A is defined as an area between an imaginary plane S1 and an imaginary plane S2. The imaginary plane S1 is a conical plane, which connects the inner peripheral edge of the first axial end surface 54 and an end edge of the radially outer surface 31 of the outer ring of the first bearing 30. This end edge of the first bearing 30 is at the rotor core 41 side. The imaginary plane S2 is a conical plane, which connects the outer peripheral edge of the first axial end surface 54 and an end edge of the radially outer surface 31 of the outer ring of the first bearing 30. This end edge of the first bearing 30 is opposite to the rotor core 41 side.

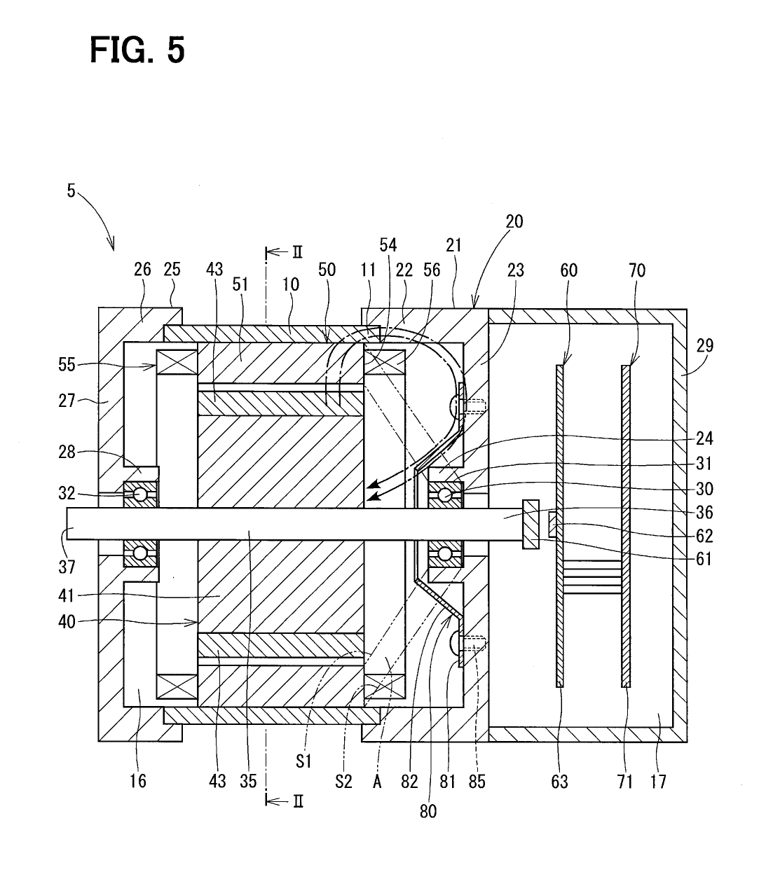

In the motor 5 configured as described above, as shown by the one-dot chain line in FIG. 5, a part of the magnetic flux, which is generated by the magnet poles 43 of the rotor core 41 and flows from the stator core 51 toward the first bottom part 23 side through the casing 10, returns to the rotor core 41 through the soft magnetic member 80. The soft magnetic member 80 positioned among the first bearing 30, the stator core 51 and the casing 10 functions as an inductor, which leads the magnetic flux returning to the rotor core 41.

As described above, the motor 5 according to the first embodiment has the housing 20 and the rotary shaft 35 made of a non-magnetic material and has the soft magnetic material 80, which crosses the space between the first axial end surface 54 of the stator core 51 and the first bearing 30. The soft magnetic member 80 is provided at the stator core 51 side relative to the first bearing 30. The soft magnetic member 80 leads the magnetic flux, which is generated from the magnet poles 43 of the rotor 40 to the first bottom part 23 side of the housing 20 through the stator core 51 and the casing 10, to the rotor core 41 and suppresses the magnetic flux leaking to the vicinity of the first axial end part 36 of the rotary shaft 35. The position sensor 60 fixed to the first axial end part 36 of the rotary shaft 35 can detect the magnet pole position of the rotor 40 accurately because the detection accuracy is suppressed from being lowered by the external disturbance magnetic field. As a result, noise sound generated by vibration of the motor 5 can be suppressed.

The end part 11 of the casing 10 protruding from the first axial end surface of the stator core 51 toward the first bearing 30 side is shorter in length of protrusion than the coil end part 56 of the coil 55. For this reason, the magnetic flux flowing from the casing 10 toward the first bottom part 23 is less likely to reach the first axial end part 36 of the rotary shaft 35. The amount of magnetic flux, which leaks to the vicinity of the first axial end part 36 of the rotary shaft 35, can be reduced.

The first accommodation compartment 16, which accommodates the rotor 40 and the stator 50 therein, and the second accommodation compartment 17, which accommodates the position sensor 60 therein, is separated by the first bottom part 23. The soft magnetic member 80 can be provided with its transverse part 82 between the stator core 51 and the first bearing 30 by fixing the first flange part 81 to the first bottom part 23 of the housing 20.

### Second Embodiment

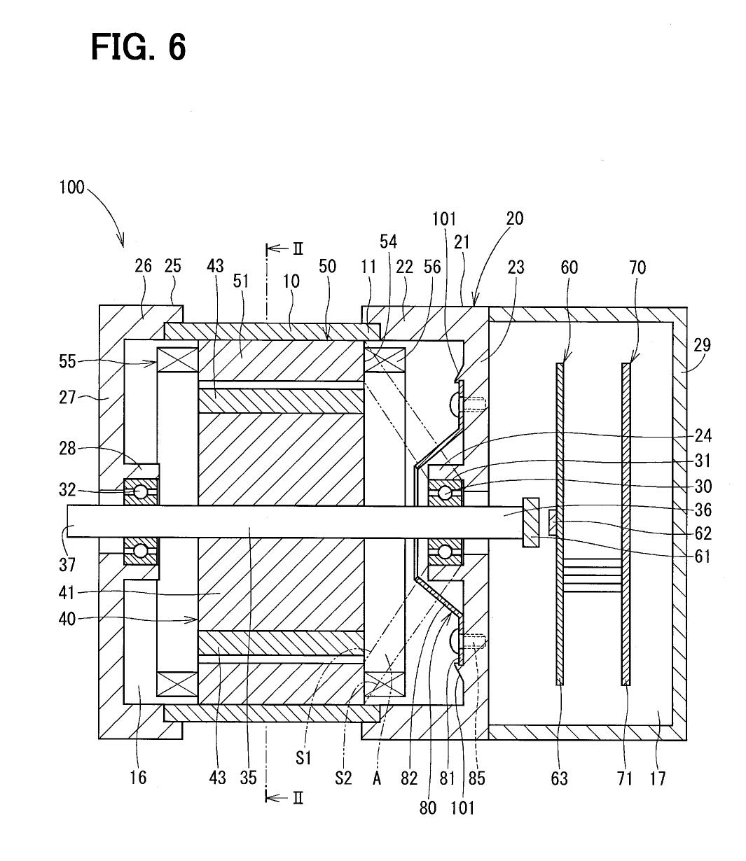

In a motor 100 according to a second embodiment, as shown in FIG. 6, the first bottom part 23 of the housing 20 has an engagement protrusion 101, which protrudes toward to the stator 50. The engagement protrusion 101 has a top end part, which is crimped radially inwardly to fix the first flange part 81 of the magnetic member 80 additionally by the bolts 85.

According to the second embodiment, in addition to the same advantage as provided by the first embodiment, the soft magnetic member 80 can be firmly fixed to the bottom part 23 of the housing 20.

### Third Embodiment

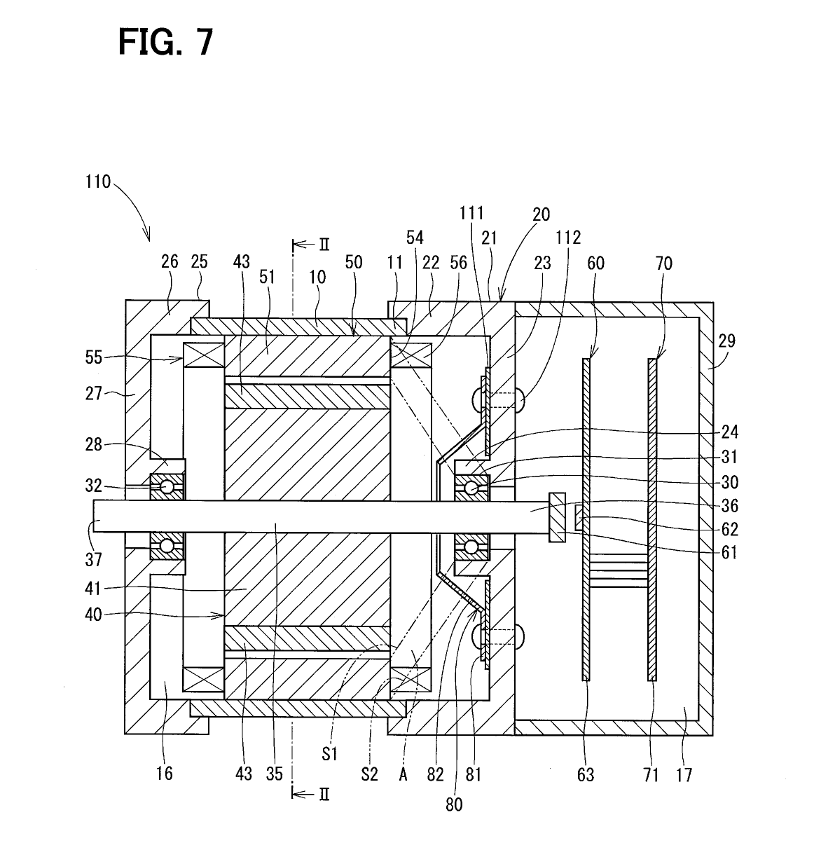

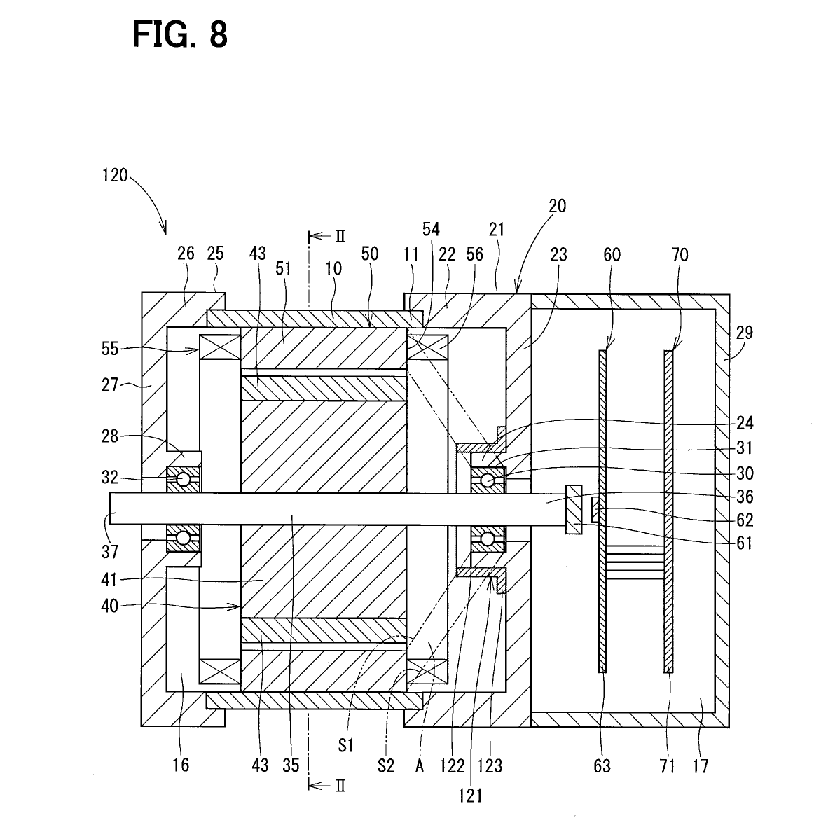

In a motor 110 according to a third embodiment, as shown in FIG. 7, a vibration absorbing member 111 is interposed between the soft magnetic member 80 and the first bottom part 23 of the housing 20. The first flange part 81 of the soft magnetic member 80 is fixed to the first bottom part 23 by rivets 112.

According to the third embodiment, in addition to the same advantage as provided by the first embodiment, metallic contact between the soft magnetic member 80 and the housing 20 is reduced and hence noise sound arising from minute vibration between the metals can be reduced.

### Fourth Embodiment

In a motor 120 according to a fourth embodiment, as shown in FIG. 7, a soft magnetic member 121 is formed of a cylindrical part 122 and a first flange part 123. The cylindrical part 122 is press-fitted on a radially outer surface of the first bearing holder part 24 of the housing 20 and crosses the space A between the first axial end surface of the stator core 51 and the first bearing 30. The first flange part 123 is formed integrally at one axial end part of the cylindrical part 122.

According to the fourth embodiment, in addition to the same advantage as provided by the first embodiment, the soft magnetic member 121 is fixed to the housing 20 without fixing members such as bolts and hence the number of component parts can be reduced.

### Fifth Embodiment

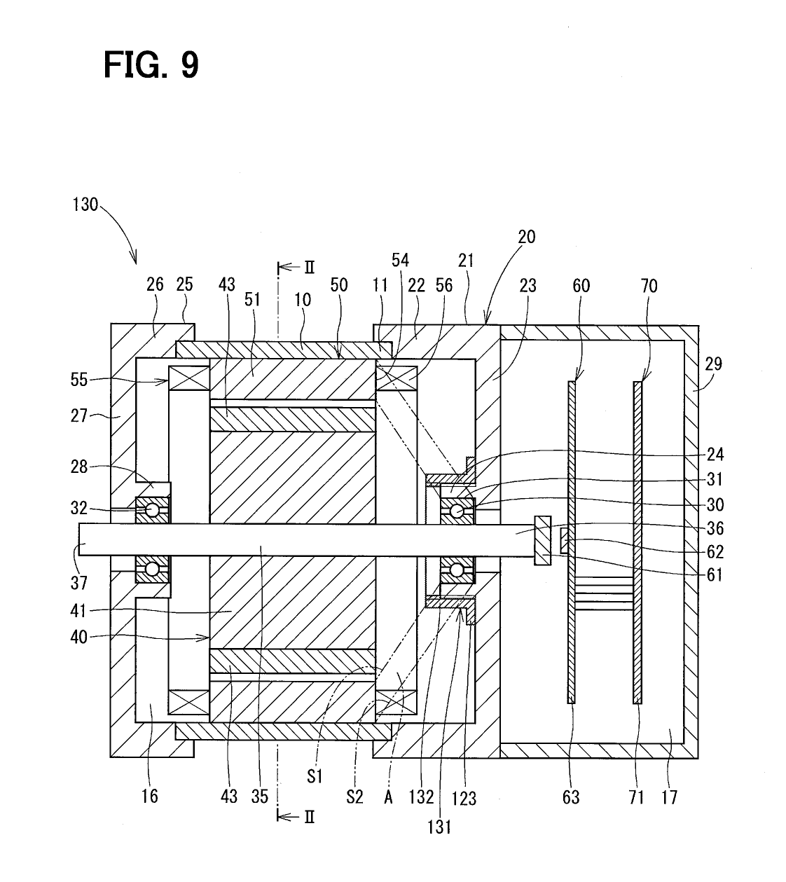

In a motor 130 according to a fifth embodiment, as shown in FIG. 9, a soft magnetic member 131 is formed of a cylindrical part 132 and a first flange part 123. The cylindrical part 132 is screw-threaded onto the first bearing holder part 24 of the housing 20.

According to the fifth embodiment, in addition to the same advantage provided by the first embodiment, the soft magnetic member 131 is fixed to the housing 20 without using fixing members such as bolts and hence the number of component parts can be reduced.

### Sixth Embodiment

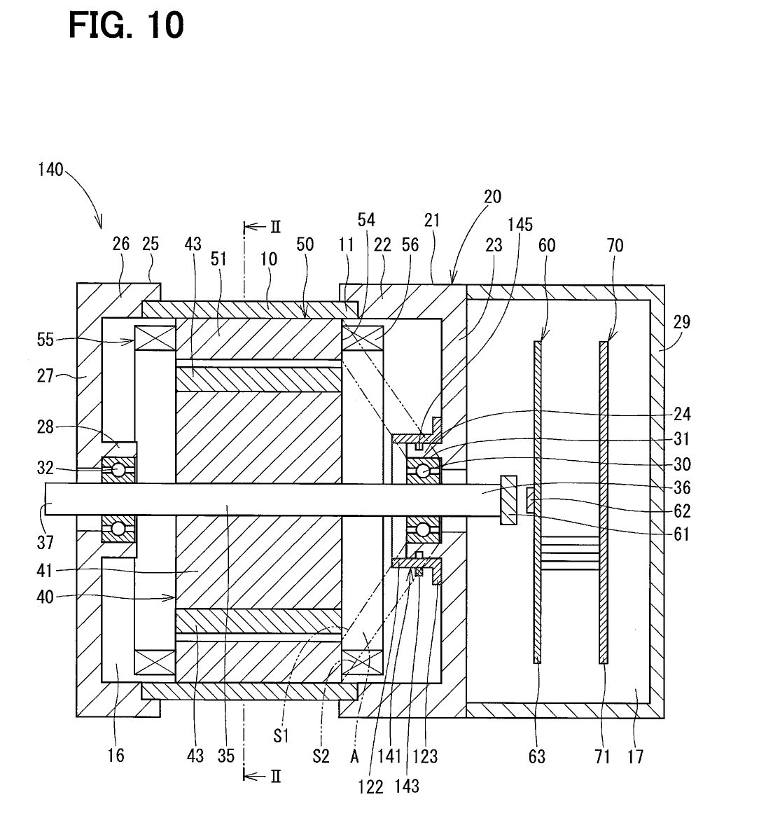

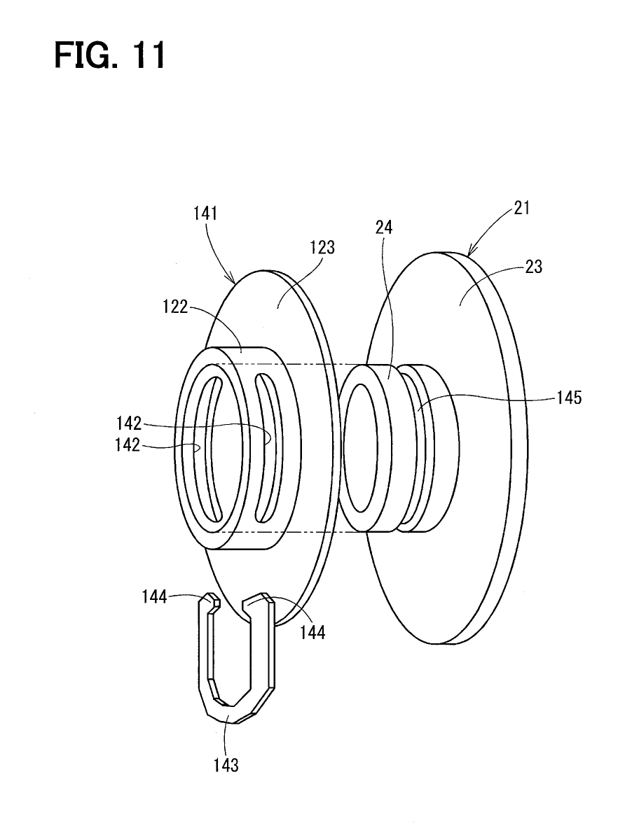

In a motor 140 according to a sixth embodiment, as shown in FIG. 10 and FIG. 11, a soft magnetic member 141 is fixed to the first bearing holder part 24 of the housing 20 by a U-shaped clip 143. The cylindrical part 122 of the soft magnetic member 141 has through holes 142, through which nails 144 of the clip 143 are passed. The clip 143 is hooked in an annular groove 145 formed on the first bearing holder part 24 thereby to fix the soft magnetic material 141 to the first bearing holder part 24.

According to the sixth embodiment, in addition to the same advantage as provided by the first embodiment, the soft magnetic member 141 can easily be attached and detached.

### Seventh Embodiment

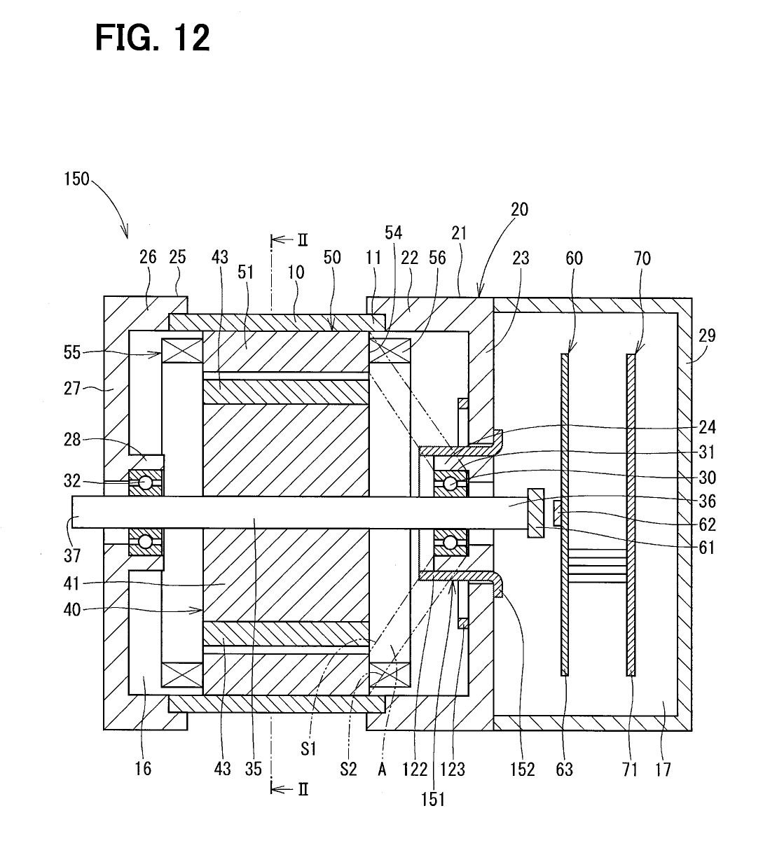

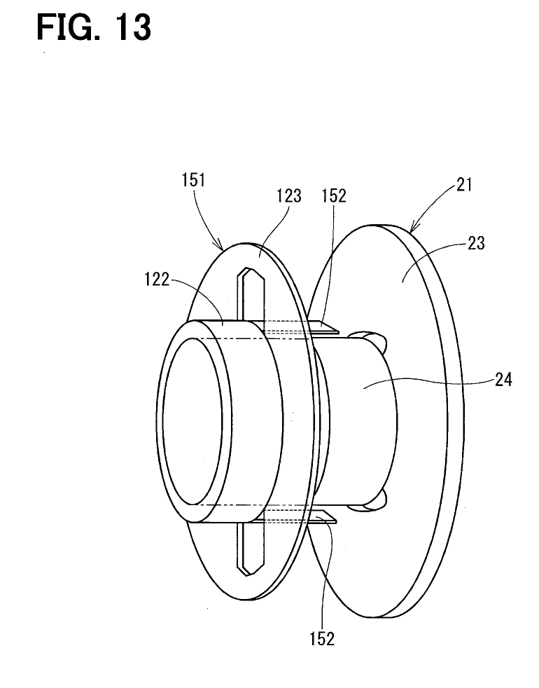

In a motor 150 according to a seventh embodiment, as shown in FIG. 12 and FIG. 13, a soft magnetic member 151 has an engagement nail 152 at one axial end thereof. The engagement nail 152 extends from the cylindrical part 122 in the axial direction, passes through the first bottom part 23 of the housing 20 and is bent in a radially outward direction at the axial end part. The soft magnetic member 151 is fixed to the first bottom part 23 by the engagement nail 152.

According to the seventh embodiment, in addition to the same advantage as provided by the first embodiment, the soft magnetic member 151 can be fixed comparatively easily.

### Eighth Embodiment

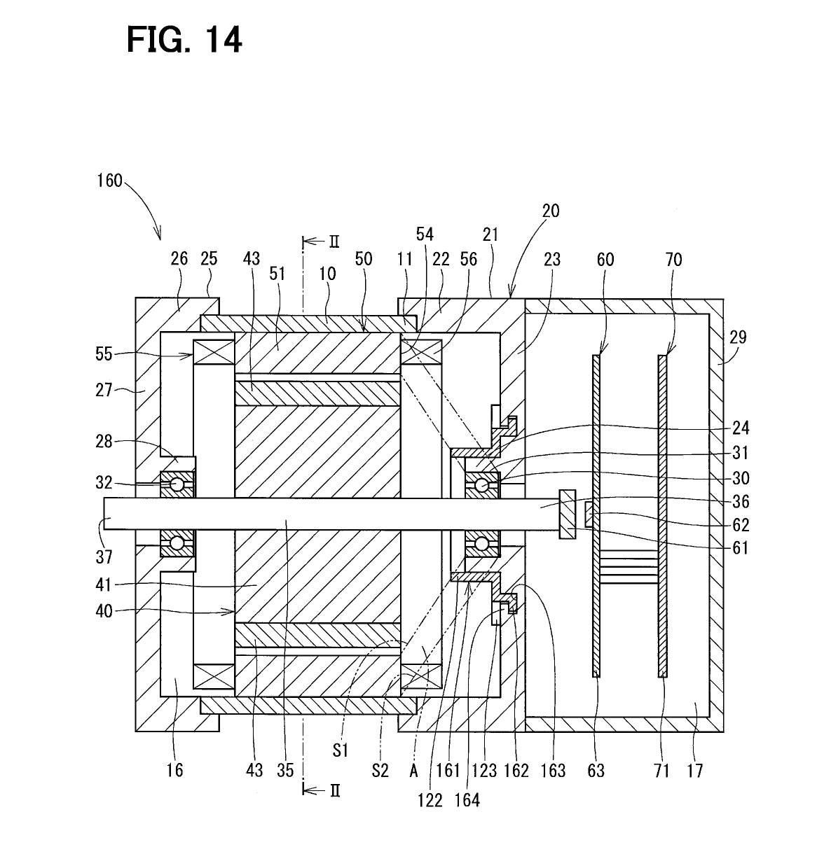

In a motor 160 according to an eighth embodiment, as shown in FIG. 14, the soft magnetic member 161 is formed with an engagement nails 162. Four engagement nails 162 are formed at equal intervals in the circumferential direction. The engagement nails 162 are turned in the circumferential direction after being fitted in recesses 163 of the first bottom part 23 of the housing 20 and engaged with engagement nails of the first bottom part 23. The soft magnetic member 161 is restricted from being pulled out by the engagement nails 162.

According to the eighth embodiment, in addition to the same advantage as provided by the first embodiment, the soft magnetic member 161 is fixed to the housing 20 without using fixing members such as bolts and hence the number of component parts can be reduced.

### Ninth Embodiment

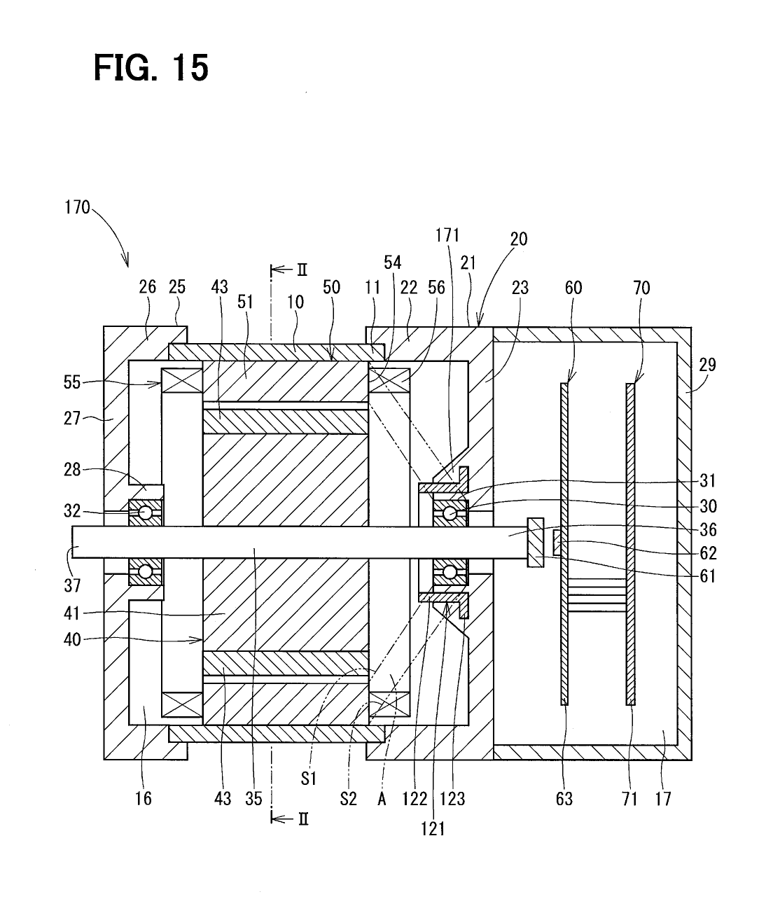

In a motor 170 according to a ninth embodiment, as shown in FIG. 15 the first flange part 123 and a part of the cylindrical part 122 of the soft magnetic member 121 are embedded in a bearing holder part 171 of the first housing part 21. The soft magnetic member 121 is insert-cast in the first housing part 21.

According to the ninth embodiment, in addition to the same advantage as provided by the first embodiment, the soft magnetic member 121 can be securely fixed to the first housing part 21.

### Tenth Embodiment

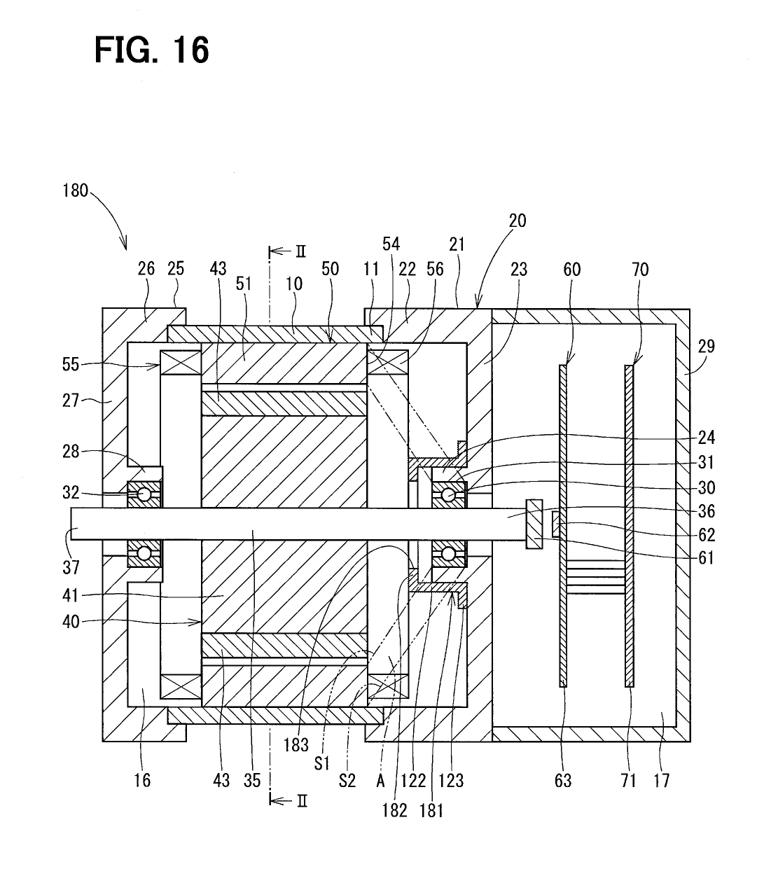

In a motor 180 according to a tenth embodiment, as shown in FIG. 16, a soft magnetic member 181 is formed with a second flange part 182 in addition to the cylindrical part 122 and the first flange part 123. The second flange part 182 is in parallel to the first flange part 123. The second flange part extends in a radially inward direction from an axial end part of the cylindrical part 122, which is at the rotor core 41 side. The second flange part 182 faces the radially inner part of the rotor core 41 in the axial direction. The second flange part 182 has an assembling hole 183, which is larger in diameter than the outer diameter of the first bearing 30. The first bearing 30 can be assembled to the bearing holder part 24 through the assembling hole 183.

According to the tenth embodiment, in addition to the same advantage as provided by the first embodiment, the area of facing between the soft magnetic member 181 and the rotor core 41 is increased. As a result, a magnetic resistance between the soft magnetic member 181 and the rotor core 41 can be reduced and hence the magnetic flux, which leaks toward the vicinity of the one end of the rotary shaft 35, be reduced further.

### Eleventh Embodiment

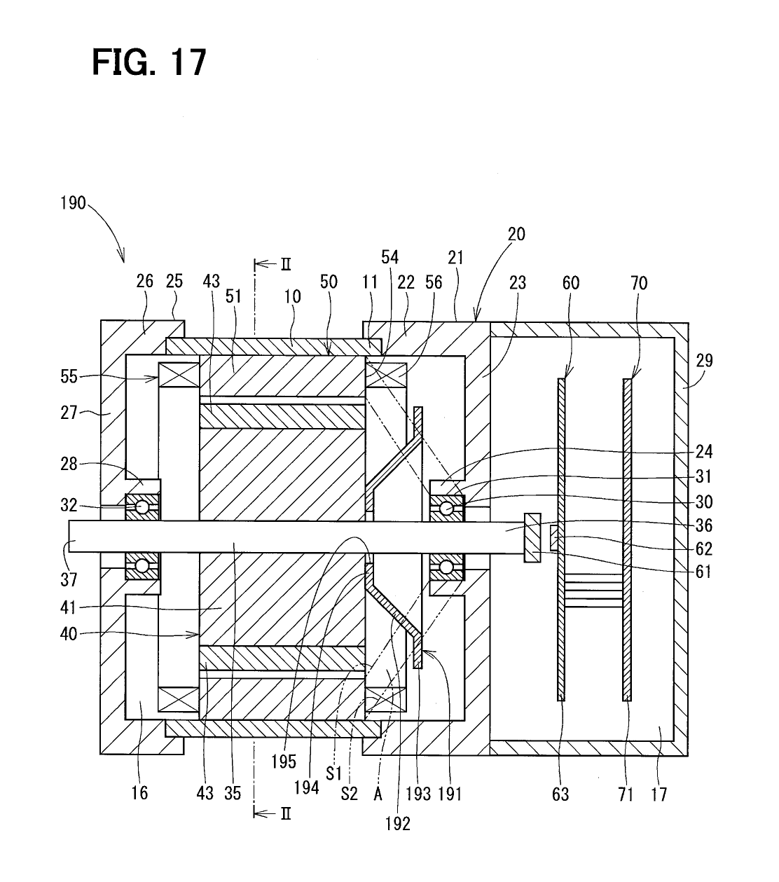

In a motor 190 according to an eleventh embodiment, as shown in FIG. 17, a soft magnetic member 191 has a transverse part 192, a first flange part 193 and a second flange part 194, which is smaller in diameter than the first flange part 193. The transverse part 192 is formed in a conical tubular shape and crosses the space A between the first axial end surface 54 of the stator core 51 and the first bearing 30. The first flange part 193 protrudes in a radially outward direction from one axial end part of the transverse part 192, which is at the first bottom part 23 side. The first flange part 191 is not fixed to the first bottom part 23 but separated away from the first bottom part 23 to a position away from the first bearing 30 in the axial direction toward the rotor 40 and the stator 50. The second flange part 194 protrudes in a radially inward direction from the other end part of the transverse part 192, which is at the rotor core 41 side. The second flange part 194 is fixed to the radially inner part of the rotor core 41 by, for example, welding. The second flange part 194 has a through hole 194, which is smaller in an inner diameter than the outer diameter of the first bearing 30.

According to the eleventh embodiment, in addition to the same advantage as provided by the first embodiment, the soft magnetic member 191 is directly fixed to the rotor core 41, to which the magnetic flux returns, and hence a closed magnetic circuit can be formed surely. As a result, the magnetic flux, which leaks to the vicinity of the first axial end part 36 of the rotary shaft 35 can be reduced further. In addition, the through hole 195 of the second flange part 194 is smaller in the inner diameter than the outer diameter of the first bearing 30, and hence the magnetic resistance between the soft magnetic member 191 and the rotor core 41 can be reduced as much as possible.

### Twelfth Embodiment

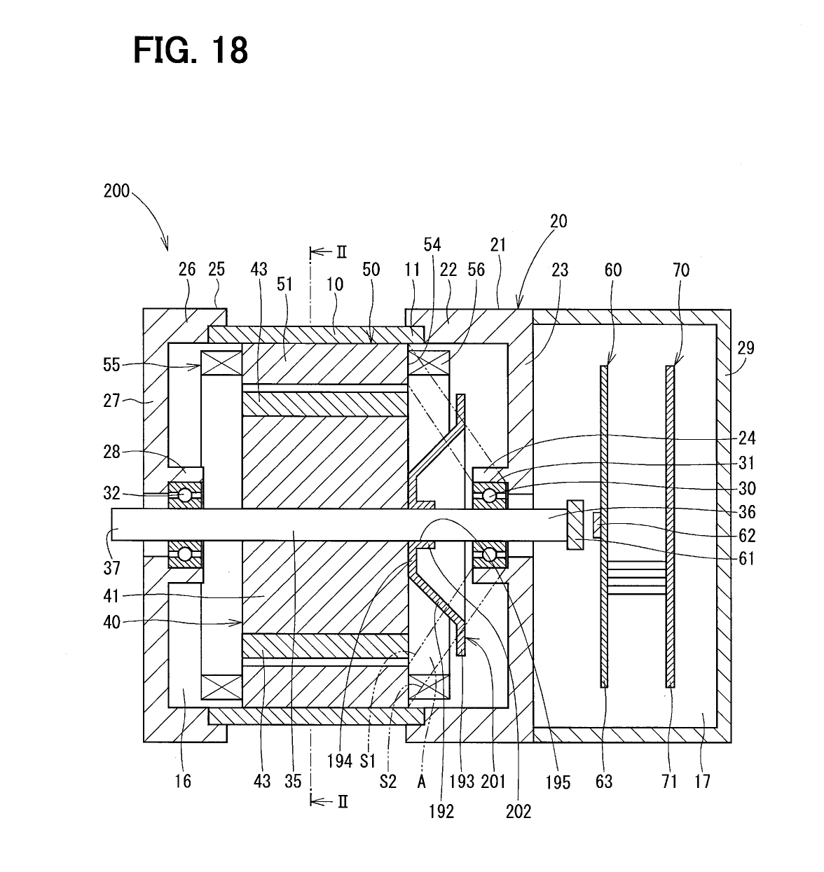

In a motor 200 according to a twelfth embodiment, as shown in FIG. 18, a soft magnetic member 201 is formed with a cylindrical press-fit part 202, which extends from the second flange part 194 in the axial direction toward the first bearing 30. The cylindrical press-fit part 202 is press-fitted on the rotary shaft 35.

According to the twelfth embodiment, in addition to the same advantage as provided by the first embodiment, the soft magnetic member 201 is fixed onto the rotary shaft 35 without using a fixing member such as bolts and hence the number of component parts can be reduced.

### Thirteenth Embodiment

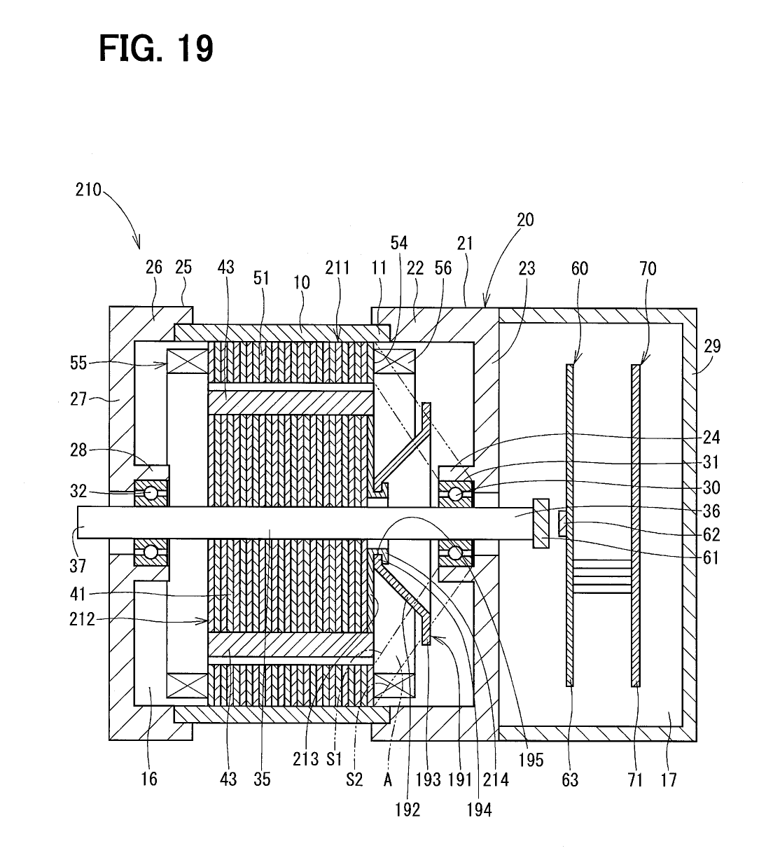

In a motor 210 according to a thirteenth embodiment, as shown in FIG. 19, a stator core 211 and a rotor core 212 are formed of stack bodies of plural metal plates, which are stacked in a thickness direction.

A metal plate 213, which is at the first bearing 30 side, among metal plates forming the rotor core 212, are crimped at its innermost peripheral part 214 in such a manner to surround the radially inner end part of the second flange part 194. Thus the soft magnetic member 191 is fixed.

According to the thirteenth embodiment, in addition to the same advantage as provided by the first embodiment, the soft magnetic member 191 is directly fixed to the rotor core 212, to which the magnetic flux returns, and hence the closed magnetic circuit can be formed surely. As a result, the magnetic flux leaking to the vicinity of the first axial end part 36 of the rotary shaft 35 can be reduced further. Since the soft magnetic member 191 is fixed to the rotor core 212 without using a fixing member such as bolts, the number of component parts can be reduced.

### Fourteenth Embodiment

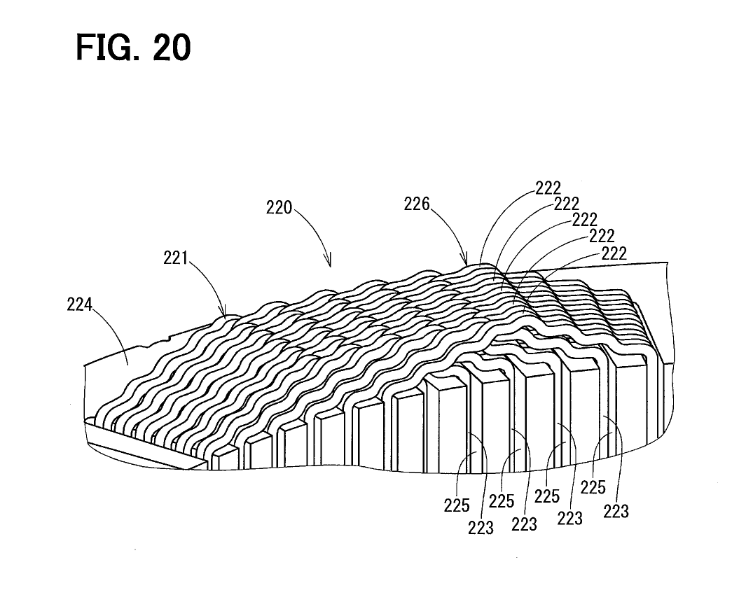

In a motor 220 according to a fourteenth embodiment, as shown in FIG. 20, linear parts 223 of plural conductor wires 222 formed in a U-shape of coils 221 are placed in slots 225 of a stator core 224 to extend in the axial direction and the linear parts 223 are electrically connected one another. The configuration other than the coils 221 is the same as the first embodiment.

The motor 220 configured as described above is compact-sized in the axial direction, because the length of the coil end part 226 of the coil 221 protruding in the axial direction is reduced. If the motor 220 is compact-sized in the axial direction, a distance of the stator core and the casing relative to the bearing is shortened and hence the magnetic flux leaking to the vicinity of the rotary shaft may tend to increase. However, the soft magnetic member reduces the magnetic flux leaking toward the rotary shaft. As a result, both advantages of the size reduction and the improved detection accuracy of the position sensor can be attained.

### Other Embodiments

As the other embodiment, the soft magnetic member may be fixed by a fixing member other than bolts and rivets. The soft magnetic member may be fixed by means other than welding even in a case that no fixing member is used.

As the other embodiment, the magnetic sensor of the position sensor may be, for example, a Hall element other than the magneto-resistive element. The position sensor may be, for example, a resolver or a rotary encoder. A rotary part of the position sensor may be fixed to the inner ring of the bearing.

As the other embodiment, the end part of the casing extending from the first end surface of the stator core toward the bearing may protrude in the axial direction the same length as or more than the coil end part of the coil.

As the other embodiment , the housing and the cover are not limited to be made of die-cast aluminum but may be made of other non-magnetic material.

As the other embodiment, the rotary shaft is not limited to be made of stainless steel but may be made of other non-magnetic materials.

As the other embodiment, the motor may be provided for an apparatus other than a vehicular electric power steering system.

What is claimed is:

1. A rotary electric machine comprising:
a housing made of a non-magnetic material;
a bearing attached to the housing;
a rotary shaft made of a non-magnetic material and supported by the bearing between a first axial end part and a second axial end part thereof;
a magnetic angular position sensor provided for detecting a rotary position of the rotary shaft, the magnetic angular position sensor having a rotary part fixed to the first axial end part of the rotary shaft or an inner ring of the bearing;
a rotor core fixed to the rotary shaft at a position, which is opposite to the rotary part in an axial direction of the rotary shaft relative to the bearing;
plural salient poles protruding from the rotary core in a radial direction of the rotary shaft;
plural magnet poles provided between adjacent two of the salient poles and fixed to the rotor core;
a stator core fixed to the housing at a position radially outside the rotor core;
plural coils wound and placed in slots of the stator core; and
a soft magnetic member crossing in a first space between the bearing and a first end surface of the stator core at the bearing side, the soft magnetic member inducing magnetic flux to flow from the stator core to the rotor core and suppressing the magnetic flux from flowing to the magnetic angular position sensor.

2. The rotary electric machine according to claim 1, further comprising:
a casing made of a soft magnetic material and firmly fitted on a radially outside surface of the stator core and fitted with the housing,
wherein the casing has an axial end part protruding in the axial direction from a first end surface of the stator core toward the bearing by a length, which is less than a coil end part of the coil protruding from the first end surface of the stator core in the axial direction.

3. The rotary electric machine according to claim 1, wherein:
the soft magnetic member is fixed to the housing.

4. The rotary electric machine according to claim 3, wherein:
the housing has a partition wall, which partitions a first space for accommodating the stator core therein from a second space for accommodating the rotary part of the magnetic angular position sensor therein and firmly fixing the bearing at a radially inner part thereof; and
the soft magnetic member has a first flange part fixed to the partition wall.

5. The rotary electric machine according to claim 4, further comprising:
a vibration absorbing member interposed between the first flange part of the soft magnetic material and the partition wall.

6. The rotary electric machine according to claim 4, wherein:
the housing is made of die-cast aluminum; and
at least the first flange part of the soft magnetic member is embedded in the housing.

7. The rotary electric machine according to claim 3, wherein:
the soft magnetic member has a cylindrical part extending in the axial direction and fixed to the housing.

8. The rotary electric machine according to claim 7, wherein:
the housing has a partition wall, which partitions a first space for accommodating the stator core therein from a second space for accommodating the rotary part of the magnetic angular position sensor therein and firmly fixing the bearing at a radially inner part thereof;
the partition wall has a cylindrical bearing holder part, in which the bearing is fitted; and
the cylindrical part of the soft magnetic member covers the bearing holder part of the housing.

9. The rotary electric machine according to claim 4, wherein:
the soft magnetic member has a second flange part, which faces the rotor core in the axial direction.

10. The rotary electric machine according to claim 9, wherein:
the second flange part of the soft magnetic member has an assembling hole, which has a diameter larger than an outer diameter of the bearing and allows the rotary shaft to pass therethrough.

11. The rotary electric machine according to claim 1, wherein:
the soft magnetic member is fixed to the rotor core.

12. The rotary electric machine according to claim 11, wherein:
the soft magnetic member has a second flange part fixed to the rotor core.

13. The rotary electric machine according to claim 12, wherein:
the second flange part of the soft magnetic member has a through hole, which has a diameter smaller than an outer diameter of the bearing and allows the rotary shaft to pass therethrough.

14. The rotary electric machine according to claim 1, wherein:
the plural coils have conductor wires formed in a U-shape and having respective linear parts positioned in slots of the stator core; and
the linear parts are connected electrically.

15. The rotary electric machine according to claim 1, wherein:
the rotary electric machine is a brushless motor used as a drive power source of a vehicular electric power steering system.
